(19) United States
(12) Patent Application Publication
(10) Pub. No.: US 2007/0255681 A1
(43) Pub. Date: Nov. 1, 2007

(54) Automated determination of relevant slice in multidimensional data sources

(75) Inventors: Ian Tien, Seattle, WA (US); Corey Hulen, Sammamish, WA (US); Chen-I Lim, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/412,499

(22) Filed: Apr. 27, 2006

(51) Int. Cl. G06F 17/30

(52) U.S. Cl. 707/2

(57) ABSTRACT

Data from sources without a current time designator is consumed in scorecard applications by automatically detecting an appropriate time slice based on a last non-empty member in a given level of dimension. Lag values are assigned depending on a level of time dimension members and the last non-empty member. Once the current time value is determined, corresponding values are used for dimensions that are fully loaded with non-empty values. Negative lag values may be used to retrieve data for future members.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Scorecards are used to provide detailed and summary analysis of KPIs and aggregated KPIs such as KPI groups, objectives, and the like. Scorecard calculations are typically specific to a defined hierarchy of the above mentioned elements, selected targets, and status indicator schemes. Business logic applications that generate, author, and analyze scorecards are typically enterprise applications with multiple users (subscribers), designers, and administrators. It is not uncommon, for organizations to provide their raw performance data to a third party and receive scorecard representations, analysis results, and similar reports. In this case, the author may not have any influence over the structure of the data source or its automation, which may be a significant limitation.

Scorecard applications may retrieve data from a multitude of data sources such as On Line Analytical Processing (OLAP) data sources. OLAP sources typically contain time dimensions which enable users to slice data from multiple hierarchical time periods, e.g. looking at sales data from 2006 Q1, then week 45, then for the month of August. When designing an OLAP source for a scorecard, users can create a “current” time member for displaying the most recent data uploaded into the cube. However, scorecard metrics very often need to source from existing OLAP sources, which may not have been designed with a current member. In this situation, a time slice is often manually set and then reset when the underlying data adds a new time period.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to automatically determining an appropriate time slice to be used in a data source without current time designation based on a last non-empty member in a given level of a dimension. Lag values may be assigned to time dimension members in the data source and corresponding data values associated with a scorecard application such that current and future time values can be determined and used in scorecard operations based on the last non-empty member.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a block diagram of an example computing operating environment;

FIG. 2 illustrates a system where example embodiments may be implemented;

FIG. 3 illustrates an example scorecard architecture according to embodiments;

FIG. 4 illustrates a screenshot of an example scorecard;

FIG. 5 illustrates a conceptual diagram of an example data table of time dimension and corresponding scorecard elements with lag parameters assigned according to embodiments;

FIG. 6 shows lag numbers by level to illustrate the relationship between lags and levels;

FIG. 7 conceptually illustrates a scorecard, its subordinate reports, associated metrics, and their data sources, where embodiments may be implemented; and

FIG. 8 illustrates a logic flow diagram for a process of determining current time in a data source without current time designation.

### DETAILED DESCRIPTION

As briefly described above, existing OLAP sources can be consumed in a scorecard application, according to embodiments, by automatically detecting the appropriate time slice to be used based on the last non-empty member in a given level of a dimension. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

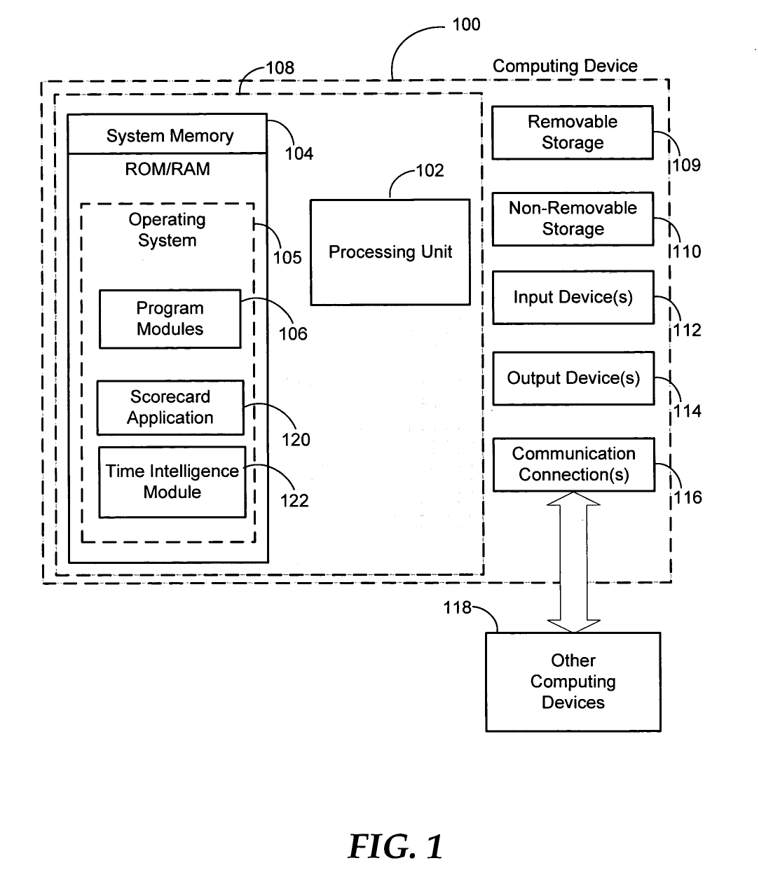

Referring now to the drawings, aspects and an exemplary operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The term “last non-empty member” as used throughout this text refers to a last valid data value among a series of temporally ordered data values in a data source. Any members or data values following the last non-empty member do not include useful information, and are considered “empty.” “Empty” members may be indicated differently in different data sources, however. For example, some data sources may have an “empty” designator, others may include a zero, or negative value to indicate that members following last non-empty member are empty. Therefore, the term “last non-empty member” should not be construed as limiting in any fashion other than as described here.

With reference to FIG. 1, one example system for implementing the embodiments includes a computing device, such as computing device 100. In a basic configuration, the computing device 100 typically includes at least one processing unit 102 and system memory 104. Depending on the exact configuration and type of computing device, the system memory 104 may be volatile (such as RAM), non-volatile (such as ROM, flash memory, etc.) or some combination of the two. System memory 104 typically includes an operating system 105 suitable for controlling the operation of a networked personal computer, such as the WINDOWS® operating systems from MICROSOFT CORPORATION of Redmond, Wash. The system memory 104 may also include one or more software applications such as program modules 106, scorecard application 120, and time intelligence module 122. Scorecard application 120 manages business evaluation methods, computes KPIs, and provides scorecard data to reporting applications. In some embodiments, scorecard application 120 may itself generate reports based on metric data.

Time intelligence module 122 is configured to automatically determine an appropriate time slice (current time) to be used based on a last non-empty member in a data source for a scorecard metric data. Time intelligence module 122 may be an integrated part of scorecard application 120 or a separate application. Scorecard application 120 and time intelligence module 122 may communicate between themselves and with other applications running on computing device 100 or on other devices. Furthermore, either one of scorecard application 120 and time intelligence module 122 may be executed in an operating system other than operating system 105. This basic configuration is illustrated in FIG. 1 by those components within dashed line 108.

The computing device 100 may have additional features or functionality. For example, the computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

The computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

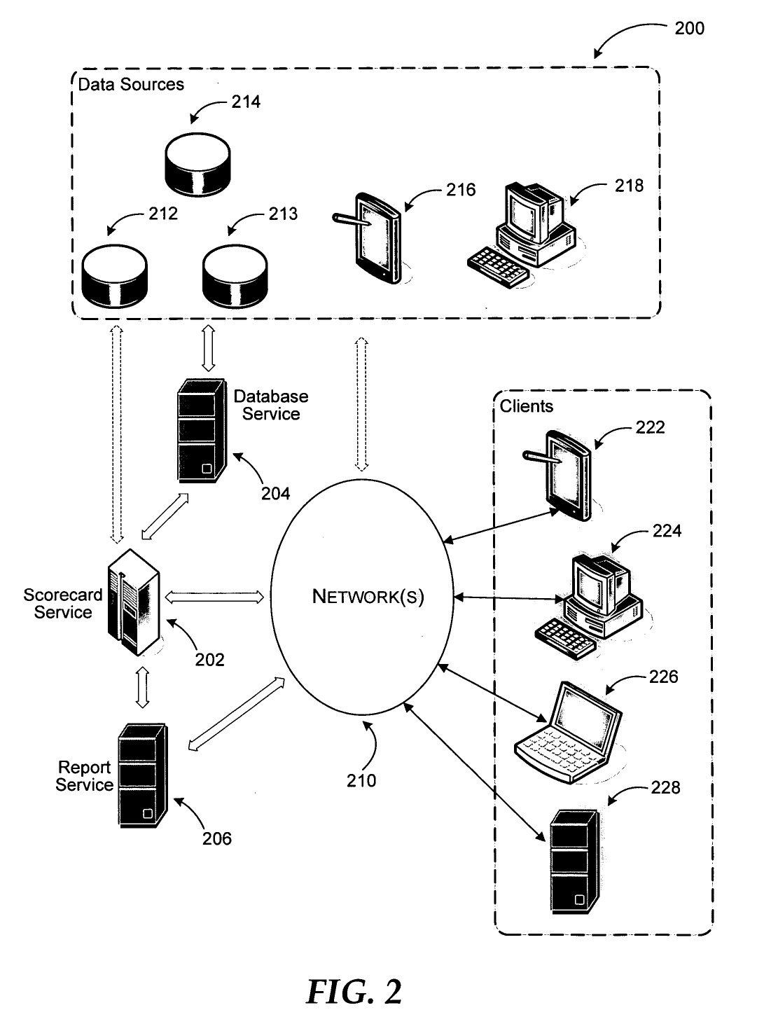

Referring to FIG. 2, a system where example embodiments may be implemented, is illustrated. System 200 may comprise any topology of servers, clients, Internet service providers, and communication media. Also, system 200 may have a static or dynamic topology. The term “client” may refer to a client application or a client device employed by a user to perform business logic operations. Scorecard service 202, database service 204, and report service 206 may also be one or more programs or a server machine executing programs associated with the server tasks. Both clients and application servers may be embodied as single device (or program) or a number of devices (programs). Similarly, data sources may include one or more data stores, input devices, and the like.

A business logic application may be run centrally on scorecard service 202 or in a distributed manner over several servers and/or client devices. Scorecard service 202 may include implementation of a number of information systems such as performance measures, business scorecards, and exception reporting. A number of organization-specific applications including, but not limited to, financial reporting, analysis, marketing analysis, customer service, and manufacturing planning applications may also be configured, deployed, and shared in system 200. In addition, the business logic application may also be run in one or more client devices and information exchanged over network(s) 210.

Data sources 212-214, 216, and 218 are examples of a number of data sources that may provide input to scorecard service 202 directly or through database service 204. Additional data sources may include SQL servers, databases, non multi-dimensional data sources such as text files or EXCEL® sheets, multi-dimensional data source such as data cubes, and the like. Database service 204 may manage the data sources, optimize queries, and the like. Elements of a scorecard built and maintained by scorecard service 202 may be associated with one or more of the data sources. Some of the data sources may not include a current time designation. In such cases, a time intelligence module as part of scorecard service 202 may determine current time values in data sources without current time designator based on a last non-empty member.

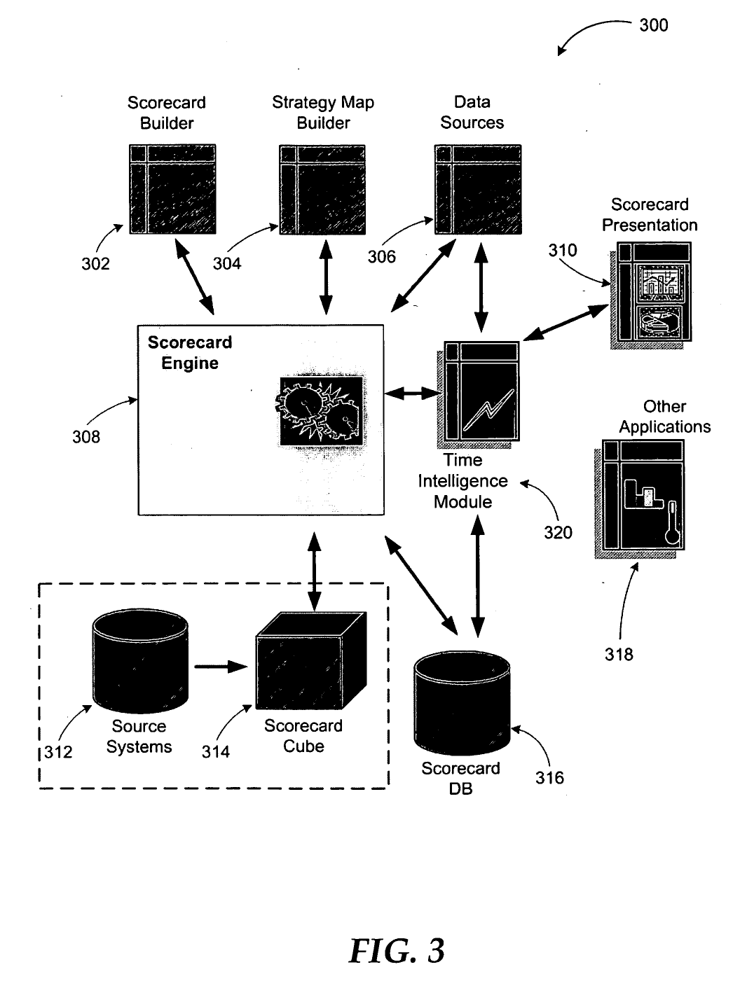

Users may interact with scorecard service 202 running the business logic application from client devices 222, 224, and 226 over network(s) 210. In one embodiment, additional applications that consume scorecard-based data may reside on scorecard service 202 or client devices 222, 224, and 226. Examples of such applications and their relation to the scorecard application are provided below in conjunction with FIG. 3.

Report service 206 may include reporting applications, such as charting applications, alerting applications, analysis applications, and the like. These applications may receive scorecard data from scorecard service 202 and provide reports directly or through scorecard service 202 to clients.

Network(s) 210 may include a secure network such as an enterprise network, or an unsecure network such as a wireless open network. Network(s) 210 provide communication between the nodes described above. By way of example, and not limitation, network(s) 210 may include wired media such as a wired network or direct-wired connection, and wireless media such as acoustic, RF, infrared and other wireless media.

Many other configurations of computing devices, applications, data sources, data distribution and analysis systems may be employed to implement a business logic application automatically generating dashboards with scorecard metrics and subordinate reporting.

Now referring to FIG. 3, example scorecard architecture 300 is illustrated. Scorecard architecture 300 may comprise any topology of processing systems, storage systems, source systems, and configuration systems. Scorecard architecture 300 may also have a static or dynamic topology.

Scorecards are a simple method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture 300, a core of the system is scorecard engine 308. Scorecard engine 308 may be an application that is arranged to evaluate performance metrics. Scorecard engine 308 may be loaded into a server, executed over a distributed network, executed in a client device, and the like.

In addition to performing scorecard calculation, scorecard engine may also provide report parameters associated with a scorecard to other applications 318. The report parameters may be determined based on a subscriber request or a user interface configuration. The user interface configuration may include a subscriber credential or a subscriber permission attribute. The report parameter may include a scorecard identifier, a scorecard view identifier, a row identifier, a column identifier, a page filter, a performance measure group identifier, or a performance measure identifier. The performance measure may be a KPI, a KPI group, or an objective. The page filter determines a period and an organizational unit for application of the scorecard calculations.

Data for evaluating various measures may be provided by a data source. The data source may include source systems 312, which provide data to a scorecard cube 314. Source systems 312 may include multi-dimensional databases such as an On Line Analytical Processing (OLAP) database, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service. Data from scorecard cube 314, scorecard database 316, or other data sources may be provided to individual elements of a scorecard such as actuals, targets, and the like associated with individual metrics (KPI's, Objectives, and the like).

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a Graphical User Interface (GUI), and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other Open Database Connectivity (ODBC)-accessible data source systems (e.g. Excel, text files, etc.). Data sources 306 may also define KPI mappings and other associated data.

Scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like. A user interface for scorecard presentation 310 may also include an overview of available scorecards for a subscriber to select from. Scorecard presentation 310 may further include a matrix or a list presentation of the scorecard data. The scorecard presentation and one or more zones for other applications may be displayed in an integrated manner.

Time intelligence module 320 is arranged to communicate with one or more of the data sources described herein and determine an appropriate time slice to be used based on a last non-empty member. According to one scenario, an OLAP source may have a time dimension with a hierarchy consisting of day, week, month, quarter, and year. A time intelligence module according to embodiments enables the scorecard server to scan through the OLAP cube at a particular level and find the last non-empty member in that level and set the notion of “current” and “previous” time selections in the data source relative to the last non-empty member. This supports both the definition of current period based on the last completed period (e.g. on June 2, one can see May's numbers) as well as the “to date” current period (e.g. on June 2, one can see the sum of June 1 and June 2).

Also, the “current” and “previous” definitions for a single data value, such as an actual or a target, can be used to automatically influence other values as well as subordinate reports. For example, defining automated time intelligence on the actual value of a KPI can have it automatically set for the KPI's targets (which may simply be variations on the first mapping created with additional filters) as well as the subordinate reports (e.g. graphs and charts based on the “current” slice of the data).

Other applications 318 may include any application that receives data associated with a report parameter and consumes the data to provide a report, perform analysis, provide alerts, perform further calculations, and the like. The data associated with the report parameter includes content data and metadata. Other applications may be selected based on the report parameter, a subscriber request, or a user interface configuration. The user interface configuration may include a subscriber credential or a subscriber permission attribute. Other applications 318 may include a graphical representation application, a database application, a data analysis application, a communications application, an alerting application, or a word processing application.

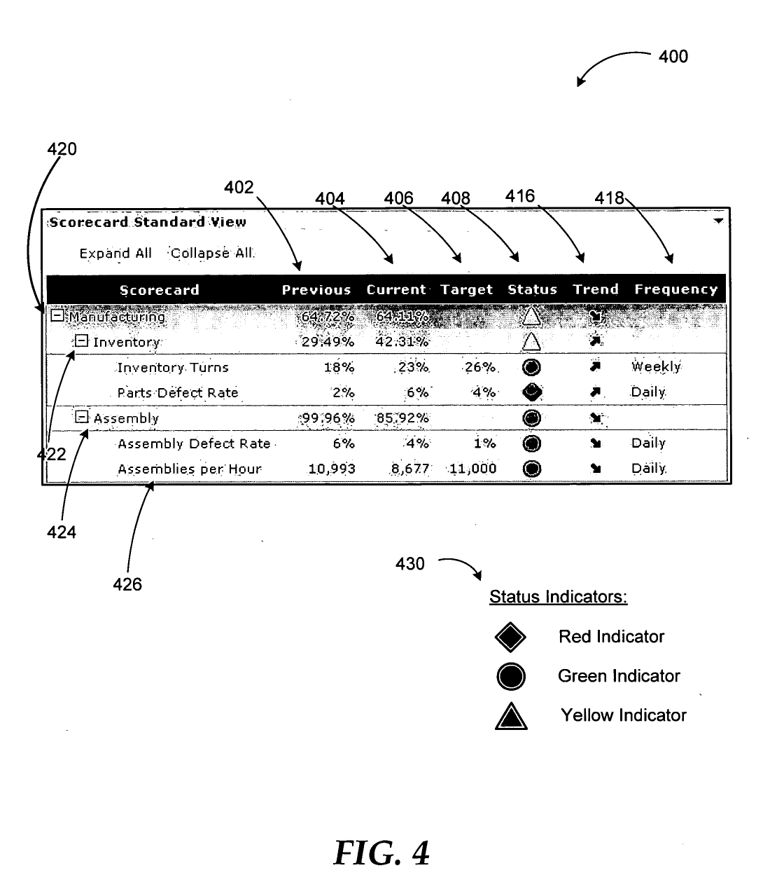

FIG. 4 illustrates a screenshot of an example scorecard. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. The shared use of KPI definition may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes. The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The trend arrows displayed in scorecard 400 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400 shows example elements perspective 420 “Manufacturing” with objectives 422 and 424 “Inventory” and “Assembly” (respectively) reporting to it. Second column 402 in scorecard 400 shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400. Target values may be retrieved from a database, entered by a user, and the like. Column 408 of scorecard 400 shows status indicators.

Status indicators 430 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands. Column 416 includes trend type arrows as explained above under KPI attributes. Column 418 shows another KPI attribute, frequency.

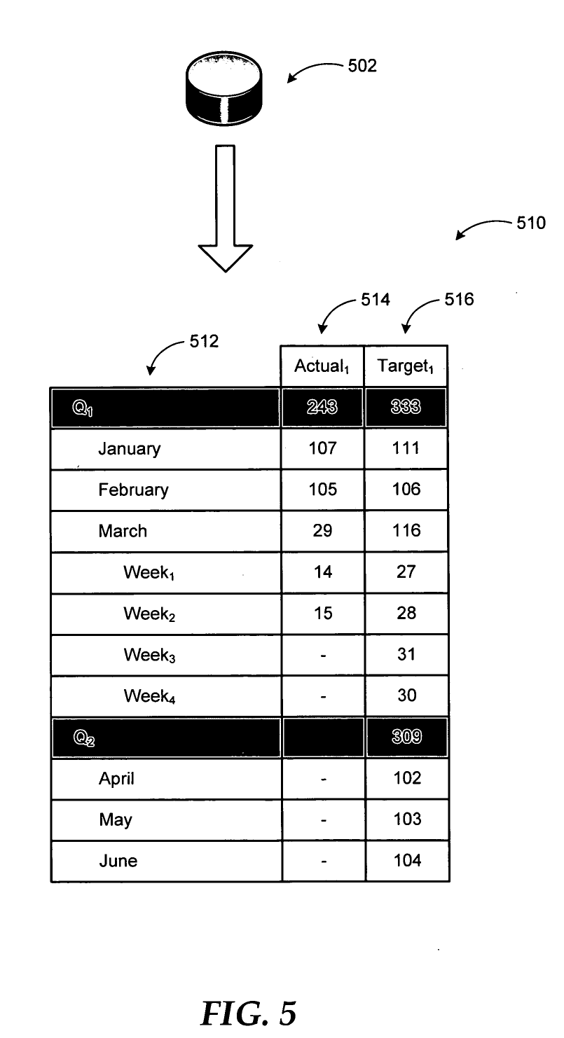

FIG. 5 illustrates a conceptual diagram of an example data table of time dimension and corresponding scorecard elements with lag parameters assigned according to embodiments. Data table 510 includes time dimension members 512 in months and weeks under each quarter and corresponding example actual values 514 and target values 516. Lag values (518) assigned to last non-empty members as well as future values are shown as well.

Data table 510 represents data from data source 502, which does not include current time designation. A scorecard application frequently retrieves data from such data sources, and current time may have to be determined manually. According to embodiments, the current time and corresponding data values may be determined using a last non-empty member such as the actual value 15 corresponding to week 2 of time dimension column 512. As described previously, non-empty member refers to a data value within the data table that includes useful data. Empty members which do not include useful data may be indicated by an empty designator (no data), a zero value, a negative value (e.g. −1, −64000, etc.), or any other designator according to a convention.

The time dimension in the data table may include several layers of members. For example, a top layer may be year followed by quarters, which include months which in turn include weeks. The example time dimension column 512 in FIG. 5 shows three months of the first quarter with the weeks of the month March listed, followed by the three months of the second quarter. The actuals column 514 includes data values for the whole months of January and February, as well as a data value in March for the sum of the first two weeks.

Following the designation of current time members, data values from the actuals column may be retrieved by the scorecard application for further operations. While the example in this figure is given in months and weeks, embodiments are not limited to these time units. The principles described herein may be implemented in any layered time dimension to determine a current time within a data source.

For the target values column 516, all of the members are non-empty (target values may be determined at the beginning of a budget year for the whole year). Therefore, the process of determining current time based on a last non-empty member may not work for the target dimension. However, each target value is associated with an actual value temporally. Hence, a current target value may simply be determined from a corresponding actual value, once that is designated as current. For example, the current target value in data table 510 is 106, which corresponds to the current actual value 105 for February as described above.

As noted above, KPIs may have different time granularities. For example, “Inventory Turns” is measured in weeks, showing values for “current” and “previous” weeks while “Parts Defect Rate” shows daily data, with “current” and “previous” day data. The “current” and “previous” for each KPI may be defined relative to two items: 1) a time granularity, which is represented by levels in a time hierarchy (such as Quarter, Month, and Week as represented in FIG. 5) and 2) an offset (also termed lag) from the last non-empty value in that level.

For example, FIG. 5 may contain sales data. By varying the time granularity and relative offset from the last non-empty, at least four different KPIs may be defined: 1) Sales for the last completed quarter; 2) Quarterly sales to date; 3) Sales from the last completed month; and 4) Monthly sales to date.

The table below summarizes the above mentioned example KPIs:

| | | Column | | | |
|---|---|---|---|---|---|
| KPI | | (measure) | Time Level | Lag | Value |
| 1) | Sales for | Actual | Quarter | 1 | N/A not shown in |
| | the last | | | | FIG. 5, this value |
| | completed | | | | would be drawn |
| | quarter | | | | from Q4 of |
| | | | | | previous year |
| 2) | Quarterly | Actual | Quarter | 0 | 243 - Q3 is the last |
| | sales to | | | | non-empty quarter |
| | date | | | | on the quarter level |
| 3) | Sales from | Actual | Month | 1 | 105 - from |
| | the last | | | | February, which is |
| | completed | | | | 1 away from the |
| | month | | | | last non-empty |
| | | | | | month, March |
| 4) | Monthly | Actual | Month | 0 | 29 - from last non- |
| | sales to | | | | empty month, March |
| | date. | | | | |

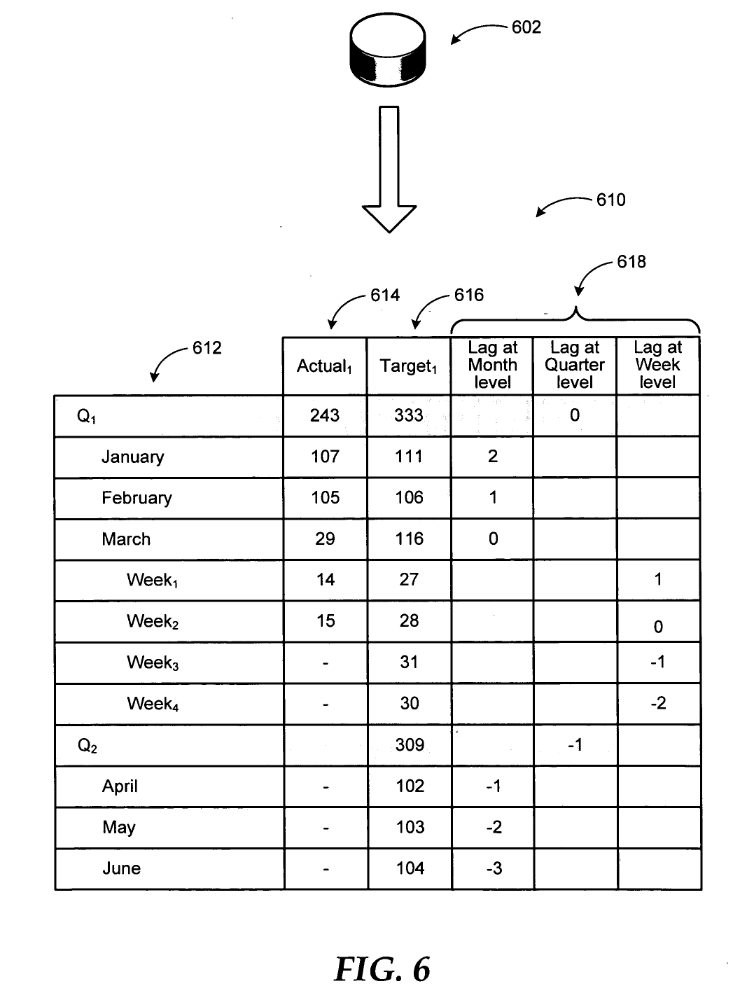

FIG. 6 shows lag numbers (618) by level to illustrate the relationship between lags and levels. Conceptual scorecard matrix 610 includes time dimension hierarchy 612, actuals 614, targets 616, and assigned lag values 618. Some or all of the data may be retrieved from data source 602. Previous values shown in FIG. 4 also key off the last non-empty values and can have various lag periods depending on what is to be compared. For example, for the “Sales from Last Completed Month KPI” the “previous” value may be 2, indicating comparison with the month prior to the “current” month with a lag of 1 (Current=Feb 2006→105, Previous=Jan 2006→107). In another example, for the “Sales from Last Completed Month” KPI the “previous” value could also be 13, indicating comparison with the prior month of the prior year (Current=Feb 2006→105, Previous=Feb 2005→Not shown in this figure).

FIG. 6 also shows that target numbers (616), such as sales forecasts, often run out ahead of actual numbers (614). Therefore, the last non-empty method may not work for target values since the future numbers may be arbitrarily forecasted. In this case, the last non-empty value of the actual may be used to refer to the target data. For example, “Sales from last completed month” could use the above described method to locate the “current” time value based on actuals and apply that context to the target to retrieve the appropriate forecast number, (in the example a target of “106” for Feb to be compared with an actual of “105” for Feb).

Negative lags may be used to bring back numbers that are leading (i.e. further ahead in time) the last non-empty. For example, to compare “Sales from last month” (level=month, lag=1, returning the month of Feb with an actual value of 105) with “Target for next month” (level=month, lag=−1, providing the month of April with a target value of 102).

The scorecards, metrics, dimensions, time units, and data sources discussed in FIGS. 2-6 are for illustration purposes only. Embodiments are not limited to the example scorecards, metrics, dimensions, time units, and data sources for determining a current time slice in a data source without current time designation. Automated determination of relevant slice in multidimensional data sources may be provided in many other ways using the principles described herein. Moreover, the same principles may be applied to other ordered dimensions beside the time dimension such as project phases, computation modules, and the like.

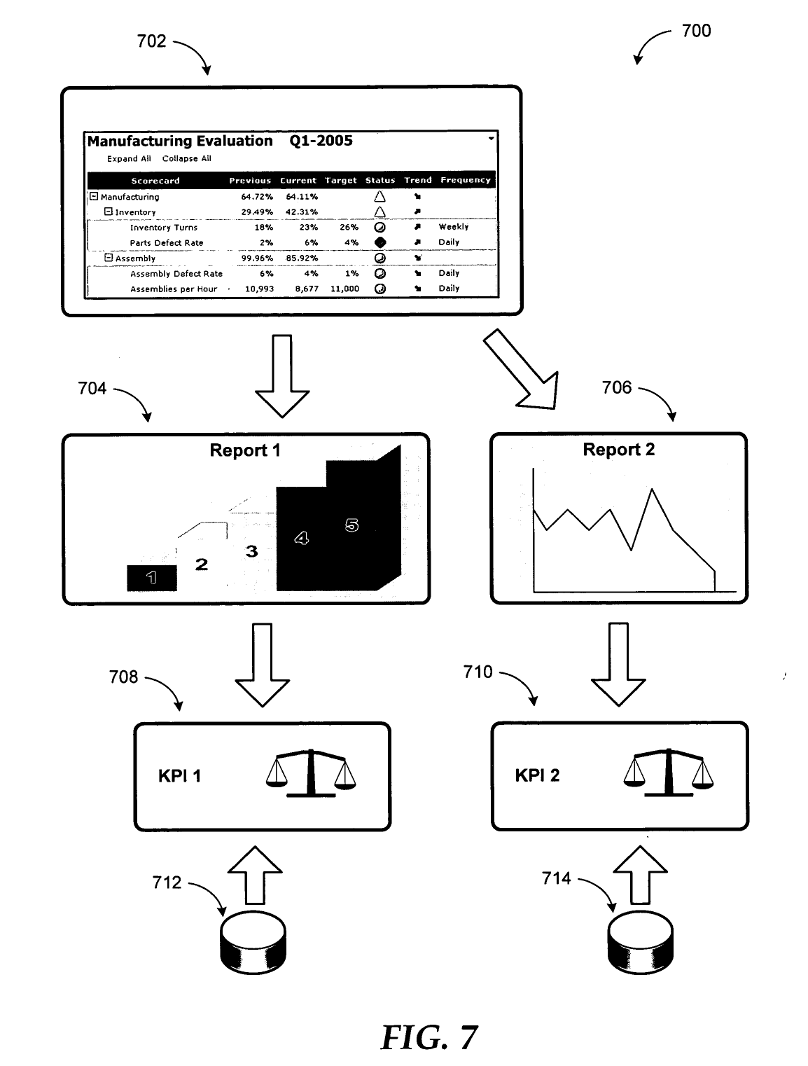

FIG. 7 conceptually illustrates a scorecard, its subordinate reports, associated metrics, and their data sources, where embodiments may be implemented. A scorecard such as the scorecard “Manufacturing Evaluation” shown in scorecard view 702 may be associated with a plurality of subordinate reports. Subordinate reports 704 and 706 are example representations of such reports. The subordinate reports themselves may be associated with one or more scorecard metrics (e.g. KPIs) each, as shown by the KPIs 708 and 710.

Each of the KPIs may receive data from one or more data sources (e.g. data sources 712 and 714). As described above, the data sources may not necessarily have current time designation. In that case, the scorecard application performing scorecard computations and determining KPI values and indicators for the subordinate reports may automatically determine a current time slice for each data source based on the last non-empty member(s). This ability may be especially critical where the data sources have different granularities (e.g. one at week level, another at month level). Different granularity means the same process cannot be applied to all data sources, but it has to be adjusted dynamically depending on the granularity of time dimension in each data source. Moreover, the data source(s) assigned to a KPI may be changed due to a number of factors such as geography, user selection, and the like.

When the KPIs are computed based on the automatically determined current time and associated data, the subordinate reports may also be updated changing not only the data values represented in the reports, but other parameters as well (e.g. axis values or scale of a chart).

According to another embodiment, the determined current time and associated data may also be used to set or modify page filter parameters. For example, a page filter parameter may define the quarter for a scorecard view. If the determined current time is in the next quarter, the page filter parameter may be adjusted accordingly to increment the quarter to the next one.

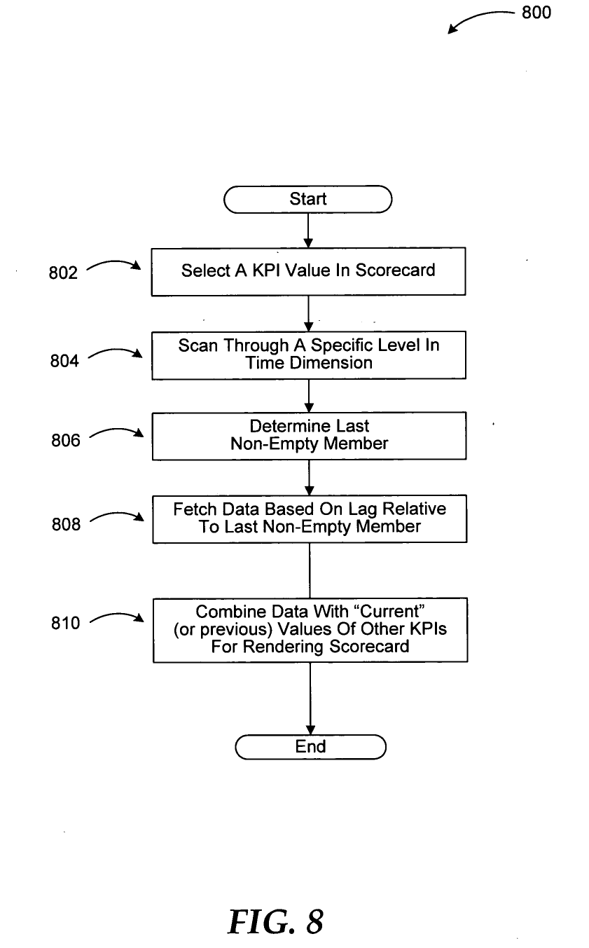

FIG. 8 illustrates a logic flow diagram for a process of determining current time in a data source without current time designation. Process 800 may be implemented in a business logic application such as a scorecard application as described in FIGS. 1 and 2.

Process 800 begins with operation 802, where a KPI value in a scorecard is selected. Typically, all KPI values in a scorecard may be scanned before rendering the scorecard. Processing advances from operation 802 to operation 804.

At operation 804, a time dimension of the data in a data source such as an OLAP source is scanned at a specific level. Time dimension members may include hierarchically structured levels such as weeks, months, quarters, and the like. Processing advances from operation 804 to operation 806.

At operation 806, a last non-empty member is determined. As described previously, a last non-empty member refers to a last useful data value in an ordered dimension. Members following the last non-empty member may have an “empty” designation, a zero value, a negative value, and the like. Once the last non-empty member is determined, processing advances to operation 808.

According to some embodiments, a lag value of “0” may be assigned to the last non-empty member designating it as the current member (current time value). At operation 808, data is retrieved based on the lag value associated with the member relative to the last non-empty member. Thus, a scorecard application may define and retrieve data for any member in the data matrix using the lag values relative to the last non-empty member. As described previously, future data values may be retrieved using negative lag values. Processing advances from operation 808 to operation 810.

At operation 810, the retrieved data is combined with values for other KPIs (current or previous) such that the scorecard can be rendered. Other operations such as filtering, customization, and the like, may also be performed depending on the scorecard application configuration. After operation 810, processing moves to a calling process for further actions.

The operations included in process 800 are for illustration purposes. Determining current time in a data source without current time designation may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for determining a current time member from a data source, comprising:
determining a last non-empty member in a temporally ordered first dimension of the data source;
assigning a lag value to the last non-empty member designating it as the current member; and
retrieving data from the first dimension for a scorecard operation using lag values associated with members relative to the current member.

2. The method of claim 1, wherein the first dimension is temporally ordered according to layered levels of a time dimension.

3. The method of claim 2, wherein the lag value is assigned based on a selected level of the time dimension.

4. The method of claim 3, wherein the lag value designating current member is assigned to a member preceding the last non-empty member, if the selected level of the time dimension includes at least one reporting level with associated empty members in the first dimension.

5. The method of claim 1, wherein an empty member is designated by one of an empty designator, a zero value, and a negative value.

6. The method of claim 1, further comprising:
designating a member of a second dimension of the data source that includes only non-empty members as a current member of the second dimension based on the member's association with the last non-empty member of the first dimension.

7. The method of claim 6, further comprising:
determining a future member of the second dimension using a negative lag value.

8. The method of claim 6, wherein the first dimension is an actuals column and the second dimension is a targets column of a scorecard matrix.

9. The method of claim 1, further comprising:
updating the scorecard when the current time member changes based on an update of the data source.

10. A computer-readable medium having computer executable instructions for determining a relevant slice in a scorecard system, the instructions comprising:
determining a last non-empty data value in a temporally ordered first dimension of the data source associated with a first scorecard metric;
if the last non-empty data value is complete, assigning a zero lag value to the last non-empty data value designating it as the current data value; else assigning a one lag value to the last non-empty data value designating a preceding data value as the current data value; and
designating a data value of a second dimension of the data source associated with the first scorecard metric that includes only non-empty data values as a current data value of the second dimension based on the second dimension's association with the first dimension.

11. The computer-readable medium of claim 10, wherein the instructions further comprise:
updating at least one parameter of a subordinate report associated with the first scorecard metric based on the current data value.

12. The computer-readable medium of claim 10, wherein the instructions further comprise:
performing a scorecard operation using the first scorecard metric and a second scorecard metric, wherein the first and the second scorecard metrics are computed based on two different current data values.

13. The computer-readable medium of claim 10, wherein the instructions further comprise:
triggering an alert associated with the first scorecard metric based on the current data value.

14. The computer-readable medium of claim 10, wherein the instructions further comprise:
updating at least one parameter of a page filter associated with a scorecard that includes the first scorecard metric.

15. The computer-readable medium of claim 10, wherein the instructions further comprise:
rendering a scorecard cache invalid, if the current data value changes as a result of an update to the data source.

16. A system for determining current data values in a data source associated with a scorecard system, comprising:
a scorecard application configured to compute scorecard metrics and provide a scorecard presentation based on the computed scorecard metrics;
the data source configured to store data values associated with the scorecard metrics in a temporally ordered manner; and
a time intelligence module configured to:
determine a last non-empty data value in a first dimension of the data source;
assign a zero lag value to the last non-empty data value designating it as the current data value, if the last non-empty data value is complete; else
assign a one lag value to the last non-empty data value designating a preceding data value as the current data value; and
provide the current data value to the scorecard application for a scorecard operation.

17. The system of claim 16, wherein the time intelligence module is further configured to designate a data value of a second dimension of the data source that includes only non-empty data values as a current data value of the second dimension based on the second dimension's association with the first dimension.

18. The system of claim 16, wherein the scorecard operation includes at least one from a set of: updating at least one parameter associated with a subordinate report, updating at least one page filter parameter, updating a computed scorecard metric, issuing a notification, updating a scorecard matrix.

19. The system of claim 16, wherein the time intelligence module is further configured to determine current data values for at least to scorecard metrics with distinct granularities.

20. The system of claim 16, wherein the data source is an On Line Analytical Processing (OLAP) data source.
